(19) United States
(12) Patent Application Publication
(10) Pub. No.: US 2006/0229877 A1
(43) Pub. Date: Oct. 12, 2006

(54) Memory usage in a text-to-speech system

(76) Inventors: Jilei Tian, Tampere (FI); Jani Nurminen, Tampere (FI)

Correspondence Address: Hollingsworth & Funk, LLC, Suite 125, 8009 34th Avenue South, Minneapolis, MN, 55425, US

(21) Appl. No.: 11/100,001

(22) Filed: Apr. 6, 2005

(51) Int. Cl. G10L 13/06

(52) U.S. Cl. 704/267

(57) ABSTRACT

In the concatenative text-to-speech system, high compression rate of duration data in the prosodic template is achieved by extracting statistical parameters describing behavior of actual duration values of instances of each given syllable, phoneme, half-phoneme, diphone, triphone or any other basic speech unit employed, and storing only the extracted statistical parameters, instead of the original duration values. Entries of each given basic unit in the prosodic template is sorted and indexed in the order of increasing duration value. Consequently, the amount of duration data can be significantly reduced, while keeping the error statistically under acceptable range.

### FIELD OF THE INVENTION

The invention relates to text-to-speech systems.

### BACKGROUND OF THE INVENTION

The simplest way to produce synthetic speech is to play long prerecorded samples of natural speech, such as single words or sentences. This concatenation method provides high quality and naturalness, but has a limited vocabulary. The method is very suitable for some announcing and information systems. However, it is quite clear that we cannot create a database of all words and common names in the world, even for only a single language. It is maybe even inappropriate to call this speech synthesis because it contains only recordings.

Thus, for unrestricted text-to-speech we have to use shorter pieces of speech signal, such as syllables, phonemes, diphones or even shorter segments. In order to achieve an unrestricted speech synthesis, current speech synthesis efforts, both in research and in applications, are dominated by methods based on concatenation of shorter pieces of speech signal spoken units, such as syllables, phonemes, diphones or even shorter segments. Such stored segments/units of natural speech are selectedfrom a database at synthesis time and prosodically modifed (pitch and/or duration), concatenated and smoothed to produce speech. New progress in the concatenative text-to-speech technology can be made mainly from two directions, either reducing the memory footprint to integrate the system into embedded system, or improving the synthesized speech quality in terms of intelligibility and naturalness. The prosodic model may consist of context information, pitch contour and duration data. With good controlling of these, gender, age, emotions, and other features in speech can be well modeled. The pitch pattern or fundamental frequency over a sentence (intonation) in natural speech is a combination of many factors. The pitch contour depends on the meaning of the sentence. For example, in normal speech the pitch slightly decreases toward the end of the sentence and when the sentence is in a question form, the pitch pattern will raise to the end of sentence. In the end of sentence there may also be a continuation rise which indicates that there is more speech to come. Finally, the pitch contour is also affected by gender, physical and emotional state, and attitude of the speaker.

The duration or time characteristics can also be investigated at several levels from phoneme (segmental) durations to sentence level timing, speaking rate, and rhythm. The segmental duration is determined by a set of rules to determine correct timing. Usually some inherent duration for phoneme is modified by rules between maximum and minimum durations. For example, consonants in non-word-initial position are shortened, emphasized words are significantly lengthened, or a stressed vowel or sonorant preceded by a voiceless plosive is lengthened. In general, the phoneme duration differs due to neighboring phonemes. At sentence level, the speech rate, rhythm, and correct placing of pauses for correct phrase boundaries are important.

In the concatenative TTS system, selection of the acoustic or speech units in the acoustic module plays a critical role in reaching high-quality synthesized speech. The determined pitch contour and duration are used to find the most match unit from acoustic inventory. Here we give more details on the unit selection.

A template-based prosodic model that can be used for acoustic unit selection includes context features cᵢⱼ, pitch contour pᵢⱼ and duration information dᵢⱼ of j-th instances of i-th syllables. In other words, the prosodic model includes context features, pitch contour and duration. In the application, for a given text, the context features cᵢ of the i-th syllable are extracted from the text through text analysis. Using the distance between the context features taken from the text and the context features pre-trained and stored in the prosodic model, a target pitch contour and duration of j*-th instance in i-th syllable are selected when this distance is minimized.

$${j}^{*} = {arg min}_{j} \{ d ( {c}_{i} , {c}_{ij} ) \} \qquad ( 1 )$$

The selected pitch contour and duration information are used to select the best acoustic unit k*-th instance of i-th syllable from database inventory.

$${k}^{*} = {arg min}_{k} \{ d ( ⌊ {p}_{{ij}^{*}} , {d}_{{ij}^{*}} , … ⌋ , [ {p}_{ik} , {d}_{ik} , … ] ) \} \qquad ( 2 )$$

In such TTS synthesizer device, the memory usage may be divided into the program code, lexicon, prosody, and voice data. The storing of this information on the prosodic model requires relatively large amount of memory capacity, which may be a problem especially in portable and mobile devices. For example, in an exemplary Mandarin Chinese TTS system there are 1,678 syllables and 79,232 instances in the prosodic model in total. Assuming that there are 47 instances for each syllable in average, the duration data will take 155 KB when two bytes are assigned to each duration value.

### SUMMARY OF THE INVENTION

An object of the invention is to reduce the storage capacity needed for the prosodic model in the TTS system.

The object of the invention is achieved by means of methods, devices, data storage, system and a program according to the attached independent claims. The preferred embodiments of the invention are disclosed in the dependent claims.

In the present invention, high compression rate of the prosodic information is achieved by extracting statistical parameters describing behavior of actual duration values of instances of each given syllable, phoneme, half-phoneme, diphone, triphone or any other basic speech unit employed, and storing only the extracted statistical parameters, instead of the original duration values. In an embodiment of the invention, entries of each given syllable are sorted and indexed in the order of increasing duration value. In an embodiment of the invention, the duration defined in a prosodic model is used only in an acoustic unit selection which is not very sensitive to errors in the duration information. Consequently, the amount of duration data can be significantly reduced, while keeping the error statistically under acceptable range.

### BRIEF DESCRIPTION OF THE DRAWINGS

In the following the invention will be described in greater detail by means of preferred embodiments with reference to the attached [accompanying] drawings, in which

FIG. 1 is a block diagram illustrating an example of a TTS system or device.

FIG. 2 is a flow diagram showing an example of a method for creating a prosodic model (compression);

FIG. 3 a flow diagram showing an example of a method for prosody generation and speech synthesis;

FIG. 4 shows histograms of durations for the whole data set and for single syllable, and the error differences between Baseline/Uniform and Uniform/Gaussian schemes; and

FIG. 5 is graph showing an example of durations with the original values and the estimated values.

### DETAILED DESCRIPTION OF THE INVENTION

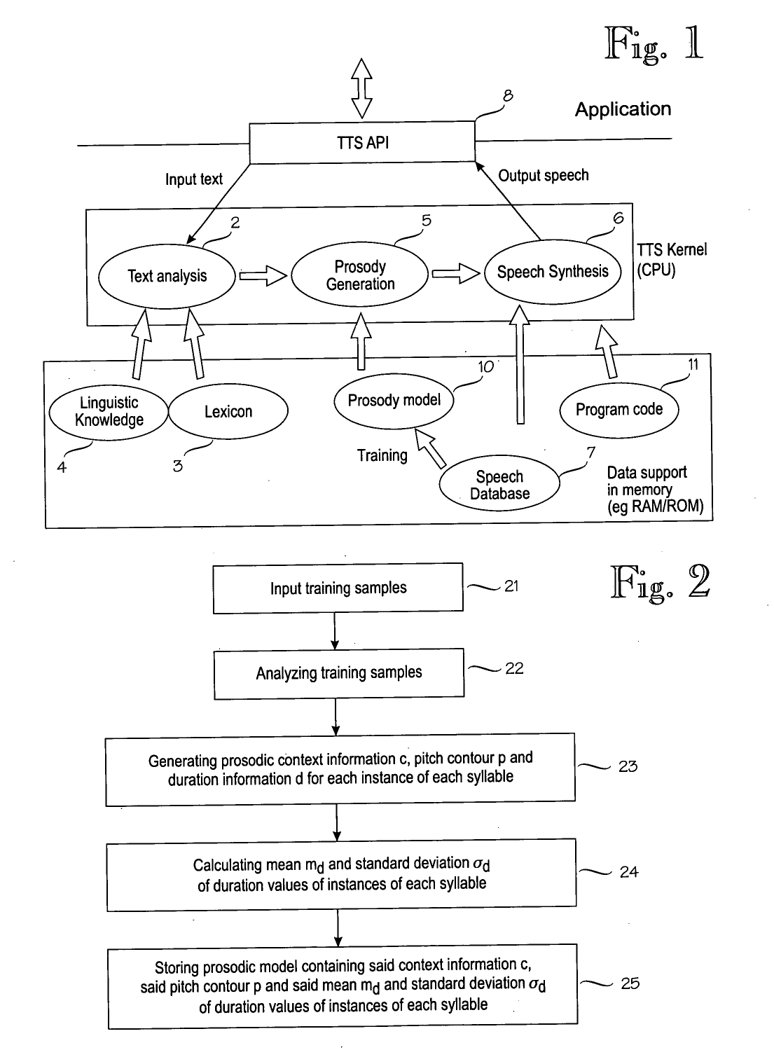

FIG. 1 shows a block diagram illustrating an example of a TTS system, and particularly a device with a TTS synthesizer feature. The TTS synthesizer feature may be implemented as an embedded application in a mobile device. An application using the TTS synthesizer feature may be a user application, such as a JAVA or C++ application run on a mobile device and communicating with the embedded TTS application through an application programming interface (API). An example of a mobile device is a mobile phone supporting Symbian operating system, such as 6670 from Nokia Inc. The invention is not intended to be restricted to embedded implementations or mobile devices, however.

The example architecture of the TTS system is particularly well working for Mandarin Chinese. It consists of three modules, text processing, prosodic processing and acoustic processing. Syllable is used as basic unit since Chinese is monosyllable language. In the text-processing module, the text is normalized and parsed to have context features for a given syllable in the text. In the prosodic module, template is pre-trained to contain context feature, pitch contour, and duration. The analyzed context feature in text module is used to find the best match in the template, and corresponding pitch contour and duration is determined.

The text-to-speech (TTS) synthesis procedure consists basically of two main phases. The first one is text analysis 2, where the input text is normalized and transcribed into a phonetic or some other linguistic representation, and the second one is the generation of speech waveforms, where the acoustic output is produced from this phonetic and prosodic information. These two phases are usually called as high- and low-level synthesis. The input text to the text analyzer 2 might be for example data from a word processor, standard ASCII from e-mail, a mobile text-message, or scanned text from a newspaper. The text analysis typically uses a lexicon 3 or dictionary which may contain a number of most frequent words of the target language (such as Mandarin) and/or a complete vocabulary associated with a particular subject area. All words associated with a particular domain are known to the system—together with as much linguistic knowledge 4 as is necessary for a natural sounding output. When the text analyzer 2 receives a text input it scans each incoming sentence, looks up each word in the word dictionary and retrieves important semantic, syntactic and phonological information needed for synthesizing the word from both segmental and prosodic viewpoints. The character string is then preprocessed and analyzed into phonetic representation which can be for example a string of phonemes with some additional information for correct intonation, duration, and stress. This phonetic information is then applied to a prosody generation 5 and a speech synthesis 6.

The prosody generation unit 5 generates the prosody, e.g. target intonation, for the phonetic input. The prosody is inputted to a speech synthesis 6 that selects speech units from a speech database 7, and concatenates them to form a synthesized speech signal output. In this example, length of a speech unit is one syllable for Mandarin Chinese. The speech database 7 contains for each syllable several alternative versions, instances, among which an instance most suitable in each situation is selected. This is called unit selection.

Thus, in a TTS synthesizer device, the memory usage may be divided into the program code 11, lexicon 3 and linguistic knowledge 4, prosody 10, and speech data in the speech database 7. The program code, when executed on a computing device, such as a processor or CPU of a mobile device, carries out the text analysis 2, prosody generation 5, and speech synthesis 6, thereby forming a TTS kernel. The TTS kernel may interface to a user application program run on the same device through a TTS application programming interface (API) 8. The TTS kernel may receive a text input from the application and apply the synthesized speech signal to the application.

### Creating a Prosodic Model Compression)

To that end, a prosodic model has been created by means of a training speech samples, i.e. natural speech samples of a model speaker (step 21 in FIG. 2). Let us assume that, in this example, the prosodic model includes context features cᵢⱼ, pitch contour pᵢⱼ and duration information dᵢⱼ of j-th instances of i-th syllables (steps 22 and 23), as explained above. The context features cᵢⱼ and the pitch contour pᵢⱼ are not relevant to the present invention but examples of other prosodic features, and they can be provided with any method known in the art. In the present invention, we are focusing on duration modeling. The basic unit is not restricted to the syllables but there are various alternatives, such as phoneme, half-phoneme, diphone, triphone or any other basic speech unit employed.

In an embodiment of the invention, a probability model is applied to model the duration for each syllable (a syllable-based duration information). In the original prosodic model, the entry of i-th syllable and j-th instance can be represented as
eᵢⱼ=(cᵢⱼ, pᵢⱼ, dᵢⱼ), (3)

Suppose that we have M instances for the syllable i in the prosodic model. The mean and the standard deviation of durations for a given syllable can be calculated as m_{d} and σ_{d}, respectively (step 24 in FIG. 2). P(d) stands for its probability distribution. Then all the entries within each syllable can be sorted based on duration in increasing order. For simplicity, we can still use eᵢⱼ to represent sorted entries.

The sorted and indexed duration dᵢⱼ can now be estimated by using m_{d} and σ_{d}. Therefore, dᵢⱼ can be completely removed since they can be estimated by m_{d} and σ_{d} using probability model. For simplicity, assume we have M duration values in the sorted order: d₁<d₂< . . . <d_{M}, and estimated as \hat{d}ⱼ. We have

$${m}_{d} = \frac{1}{M} \cdot {\sum }_{j = 1}^{M} {d}_{j} \\ and \\ {σ}_{d} = \sqrt{\frac{1}{M - 1} \cdot {\sum }_{j = 1}^{M} {( {d}_{j} - {m}_{d} )}^{2}} \qquad ( 4 )$$

The creation and training of the prosodic model are typically performed by a program code executed on a separate computer device, such as PC, in which case the functions of FIG. 1 are embodied in such computer device for training purposes. The creation and training of the prosodic model may be performed also by a executable program run in a TTS synthesizer device itself. After the prosodic model has been created, as an initial one-time operation, the model is stored in a memory of a TTS synthesizer device. In other words, context information cᵢⱼ, the pitch contour pᵢⱼ and the mean m_{d} and the standard deviation σ_{d}, of durations are stored for each syllable stored in a speech database 7 so that entries within each syllable are indexed based on duration in increasing order. Also the probability model or other statistical function employed is stored in or known to the synthesizer device. FIG. 1 illustrates also such device, typically without the training functionality.

### Prosody Generation (Decompression) and Speech Synthesis

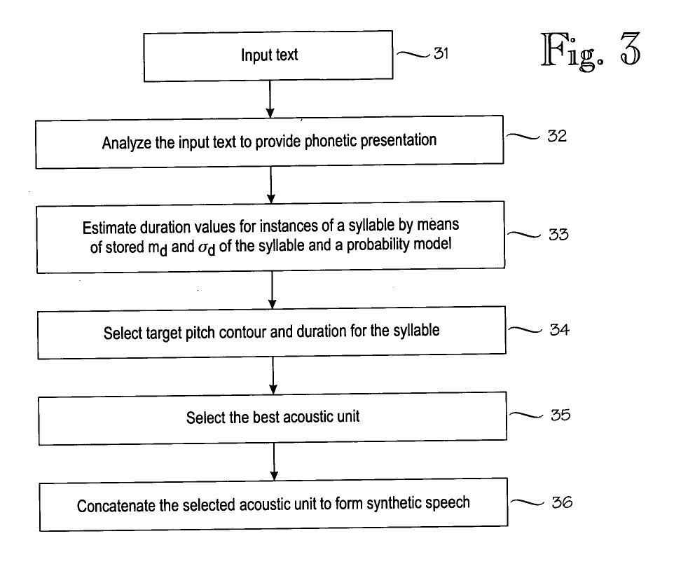

In normal operation of the TTS synthesizer shown in FIG. 1, a text input is received to the text analysis block 2 (step 31 in FIG. 3), where the input text is normalized and transcribed into a phonetic or some other linguistic representation (step 32). In the application, for a given text, the context features cᵢ of the i-th syllable are also extracted from the text through text analysis. This generated phonetic information is then applied to the prosody generation block 5.

In the prosody generation 5, using the distance between the context features cᵢ taken from the text and the context features pre-trained and stored in the prosodic model, a target pitch contour and duration of j*-th instance in i-th syllable are selected when distance is minimized, in accordance with equation (1), for example (step 34 in FIG. 3). As the duration duration values dᵢⱼ were not stored in the memory of the synthesizer, the duration dᵢⱼ is estimated by using probability model and m_{d} and σ_{d} stored in the memory (step 33). In the following, we will derive an equation for estimating duration values.

For simplicity, assume we have M duration values in the sorted order: d₁<d₂< . . . <d_{M}, and estimated as \hat{d}ⱼ. We have

$${m}_{d} = \frac{1}{M} \cdot {\sum }_{j = 1}^{M} {d}_{j} \\ and \\ {σ}_{d} = \sqrt{\frac{1}{M - 1} \cdot {\sum }_{j = 1}^{M} {( {d}_{j} - {m}_{d} )}^{2}} \qquad ( 4 )$$

Assume Lⱼ=\hat{d}ⱼ−\hat{d}ⱼ₋₁, Moreover, let the lower and upper bounds of duration be dₗ and dₕ. Then, the following condition should be approximately met

$$P ( {d}_{j} ) \cdot {L}_{j} = Constant ⇒ {L}_{j} = \frac{Constant}{P ( {d}_{j} )} \qquad ( 5 )$$

Clearly

$${\sum }_{j = 1}^{M} {L}_{j} = {d}_{h} - {d}_{l} \qquad ( 6 )$$

By inserting equation (5) into (6), we have

$$Constant = \frac{{d}_{h} - {d}_{l}}{{\sum }_{j = 1}^{M} \frac{1}{P ( {d}_{j} )}} \qquad ( 7 )$$

Thus, the duration values can be recursively estimated by

$${\hat{d}}_{j , new} = {\hat{d}}_{j - 1 , new} + \frac{\frac{1}{P ( {d}_{j - 1 , old} )}}{{\sum }_{j = 1}^{M} \frac{1}{P ( {d}_{j - 1 , old} )}} \cdot ( {d}_{h} - {d}_{l} ) \qquad ( 8 )$$

Examples of probability models that can be used in the present invention include Uniform probability model and Gaussian probability model.

For the Uniform probability model, the equation (8) can be re-written as

$${\hat{d}}_{j} = {\hat{d}}_{j - 1} + \frac{1}{N} \cdot ( {d}_{h} - {d}_{l} ) = {d}_{l} + \frac{( {d}_{h} - {d}_{l} )}{N} \cdot i \qquad ( 9 )$$

The estimated duration can be calculated efficiently without recursion.

For the Gaussian probability model, the Equation (8) can be re-written as

$${\hat{d}}_{j , new} = {\hat{d}}_{j - 1 , new} + \frac{{ⅇ}^{\frac{1}{2} {( \frac{{d}_{j , old} - {m}_{d}}{{σ}_{d}} )}^{2}}}{{\sum }_{j = 1}^{M} {ⅇ}^{\frac{1}{2} {( \frac{{d}_{j , old} - {m}_{d}}{{σ}_{d}} )}^{2}}} \cdot ( {d}_{h} - {d}_{l} ) \qquad ( 10 )$$

As can be seen from equation (10), the recursive formula for the Gaussian probability model can be computationally expensive.

In an embodiment of the invention, curve fitting to the sorted duration curve (d₁<d₂< . . . <d_{M}) shown in FIG. 5. is employed instead of a probability model. By duration curve fitting, some polynomial, spline, or even vector quantization can be applied. In theory, this approach can be equivalent to the probability model, but can offer a lower computational complexity.

When estimated duration values have been provided by one of the equations (8), (9) or (10), for example, the prosodic information is inputted to the speech synthesis 6. In the unit selection, the duration distance is used with many other distance measures, such as the pitch contour distance, is used to select the best acoustic unit k*-th instance of i-th syllable from speech database 7 according to equation (2), for example (step 35). High accuracy of duration information in the unit selection is not required since the unit selection criterion is not very sensitive to errors in the duration information.

Index of the selected estimated duration points to the instance within the syllable in the indexed sorted database 7. The selected instance or acoustic unit is then concatenated to previously and subsequently selected acoustic units to form a synthesized speech signal output (step 36).

### EXAMPLES

To demonstrate the properties of the proposed method, practical experiments were carried out using the prosodic model in a TTS system developed for Mandarin language, consisting of 79,232 instances and 1,678 syllables from a single female speaker. For each of the syllables, the durations are first automatically extracted and then manually validated. Finally all the entries within each syllable are sorted based on the duration values in increasing order. The mean and the standard deviation are calculated for each syllable. Three scenarios are tested.
1. Only the mean is used for each syllable, denoted as ‘Baseline’;
2. The mean and the standard deviation are used for each syllable, with the uniform probability duration model, denoted as ‘Uniform’;
3. The mean and the standard deviation are used for each syllable, with the Gaussian probability duration model, denoted as ‘Gaussian’;

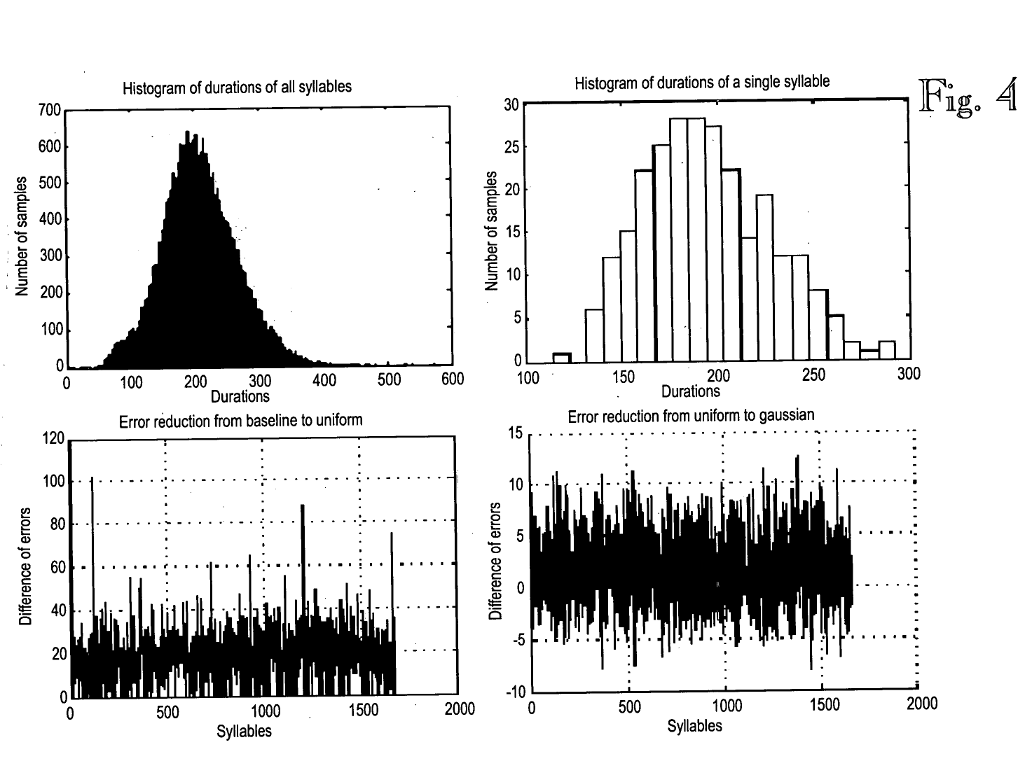

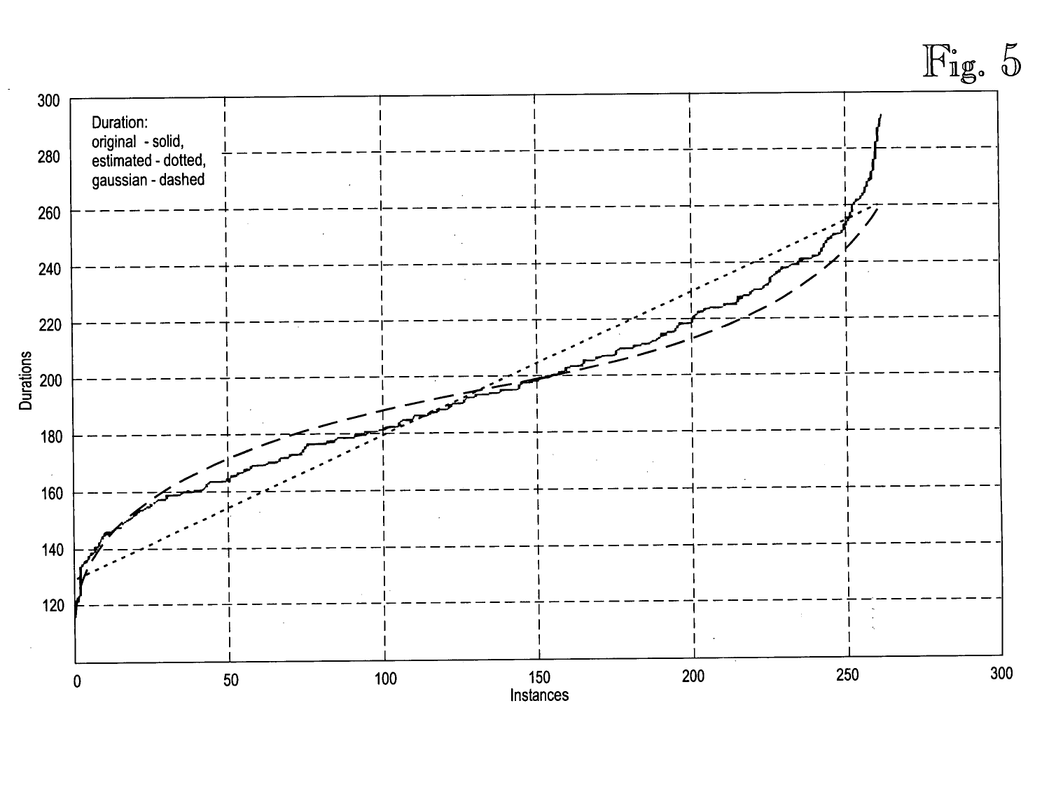

Table 1 compares the performance of duration modeling among Baseline, Uniform and Gaussian models. The Gaussian scheme performs best with smallest average error and variance. It can get explained from FIG. 4 which shows the histograms of durations for the whole data set and for single syllable, and the error differences between Baseline/Uniform and Uniform/Gaussian schemes. The histograms of the durations for all syllables and a single syllable exhibit Gaussian-like distribution. Therefore the Gaussian probability model can fit the data better than the uniform probability model. Since only the mean is used for the baseline, it models the duration even worse due to the lack of statistical parameters. FIG. 4 also shows the error improvement from the baseline to Uniform, and finally to Gaussian schemes.

TABLE 1

| | Baseline | Uniform | Gaussian |
|---|---|---|---|
| Mean of absolute error | 26.28 | 7.97 | 6.59 |
| Standard deviation of | 12.78 | 5.22 | 4.36 |
| absolute error | | | |

FIG. 5 shows an example of durations with the original values and the estimated values. The original duration values are compared with the estimated duration values. The original duration values are arbitrarily taken from a single syllable in this example. Both uniform and Gaussian models are used to estimate the duration values. Here it is also possible to verify that Gaussian modeling gives better estimates of duration values than uniform modeling.

Though the Gaussian model provides better performance, the uniform model has a very light computational load with acceptable error. Thus, the uniform scheme is preferred in our implementation as a trade-off between memory saving, computational complexity and performance.

In accordance with the principles of the invention, only the mean and the standard deviation need to be saved for each syllable. By assigning 1 byte for mean and 1 byte for standard deviation, only two bytes are needed for modeling the durations of one syllable. Since there are 1,678 syllables, thus the total memory needed for the duration information is: 1678×2=3356 B=3.3 KB. Originally, the duration information needs 79,232 instances×2 Bytes=155 KB, i.e. about 50 times the memory requirement of the present invention. The memory of duration information is reduced from the original 155 KB to the current 3.3 KB, while still keeping the error statistically under acceptable range.

The invention enables an efficient TTS engine implementation that can be used in the user interfaces of future mobile devices and multimedia systems.

It will be obvious to a person skilled in the art that, as the technology advances, the inventive concept can be implemented in various ways. The invention and its embodiments are not limited to the examples described above but may vary within the scope of the claims.

1. A method of creating prosodic information for a concatenative text-to-speech synthesis system, comprising
analysing training speech samples and generating acoustic units and associated prosodic information for selection of said acoustic units, said prosodic information including first duration information,
compressing the first duration information by producing statistical data describing the behavior of the first duration information,
storing said prosodic information wherein the first duration information is replaced by said statistical data, thereby reducing a memory capacity required for storing said prosodic information.

2. A method according to claim 1, wherein said statistical data include statistical parameters of durations for each given syllable, phoneme, half-phoneme, diphone, triphone or any other basic speech unit employed among the acoustic units.

3. A method according to claim 1, wherein said statistical data describe behavior of duration value entries of all instances within each given syllable, phoneme, half-phoneme, diphone, triphone or any other basic speech unit employed.

4. A method according to claim 1, wherein said statistical data include at least one of a mean value and a deviation of durations for each given syllable, phoneme, half-phoneme, diphone, triphone or any other basic speech unit employed.

5. A method according to claim 1, comprising sorting entries of each given syllable, phoneme, half-phoneme, diphone, triphone or any other basic speech unit employed in the order of increasing duration values.

6. A method for concatenative text-to-speech synthesis, comprising
inputting a text,
analyzing the text and producing phonetic presentation of the text,
selecting from a memory, based on said phonetic presentation, prestored prosodic information including compressed duration information in form of statistical data that describes behavior of first duration information of a given syllable, phoneme, half-phoneme, diphone, triphone or any other basic speech unit employed,
decompressing said compressed duration information by producing from said statistical data an estimation of said first duration information of the syllable, phoneme, half-phoneme, diphone, triphone or any other basic speech unit employed by means of a statistical function,
selecting, based on the estimation of said first duration information, a stored acoustic unit of the syllable, phoneme, half-phoneme, diphone, triphone or any other basic speech unit employed from an acoustic data database to be concatenated to form synthetic speech.

7. A method according to claim 6, wherein said statistical function includes one of: a probability model; uniform probability model; Gaussian probability model; curve fitting to a sorted duration curve; polynomial approximation; spline-based approximation; and vector quantization.

8. A method according to claim 6, wherein said statistical data describe behavior of duration value entries of all instances within each given syllable, phoneme, half-phoneme, diphone, triphone or any other basic speech unit employed.

9. A method according to claim 6, wherein said statistical data include at least one of: statistical parameters of durations for each given syllable, phoneme, half-phoneme, diphone, triphone or any other basic speech unit employed among the acoustic units; a mean value of durations for each given syllable, phoneme, half-phoneme, diphone, triphone or any other basic speech unit employed; and a deviation of durations for each given syllable, phoneme, half-phoneme, diphone, triphone or any other basic speech unit employed.

10. A method according to claim 1, wherein entries of each given syllable, phoneme, half-phoneme, diphone, triphone or any other basic speech unit employed in the acoustic data database are in the order of increasing duration values.

11. A device for a concatenative text-to-speech synthesis, comprising
a text analyzer producing phonetic presentation of a text input;
a memory storing a lexicon for the text analyzer, voice data including acoustic units, and associated prosodic information for selection of said acoustic units, said prosodic information including compressed duration information in form of statistical data that describes behavior of first duration information of each syllable, phoneme, half-phoneme, diphone, triphone or any other basic speech unit employed,
decompressor decompressing said compressed duration information by a predetermined statistical function producing an estimation of said first duration information of the syllable, phoneme, half-phoneme, diphone, triphone or any other basic speech unit employed based on the statistical data;
a selector selecting, based on the estimation of said first duration information and other prosodic information, a stored acoustic unit of the syllable, phoneme, half-phoneme, diphone, triphone or any other basic speech unit employed from an acoustic data database to be concatenated to form synthetic speech.

12. A device according to claim 11, wherein said statistical function includes one of: a probability model; uniform probability model; Gaussian probability model; curve fitting to a sorted duration curve; polynomial quantization; spline quantization; and vector quantization.

13. A device according to claim 11, wherein said statistical data describe behavior of duration value entries of all instances within each given syllable, phoneme, half-phoneme, diphone, triphone or any other basic speech unit employed.

14. A device according to claim 11, wherein said statistical data include at least one of: statistical parameters of durations for each given syllable, phoneme, half-phoneme, diphone, triphone or any other basic speech unit employed among the acoustic units; a mean value of durations for each given syllable, phoneme, half-phoneme, diphone, triphone or any other basic speech unit employed; and a deviation of durations for each given syllable, phoneme, half-phoneme, diphone, triphone or any other basic speech unit employed.

15. A device according to claim 11, wherein said device is a mobile device comprising an executable program code configured to implement the text analyzer, the decompressor and the selector.

16. A mobile communication device, comprising
a data processing unit;
a memory storing a lexicon for text analysis, voice data including acoustic units, and associated prosodic information for selection of said acoustic units, said prosodic information including compressed duration information in form of statistical data that describes behavior of first duration information of each syllable, and a program code that causes the data processing unit
to analyze the text and producing phonetic presentation of a text input,
to select from said memory, based on said phonetic presentation, compressed duration information of a given syllable, phoneme, half-phoneme, diphone, triphone or any other basic speech unit employed,
to decompress said compressed duration information by producing from said statistical data an estimation of said first duration information of the syllable, phoneme, half-phoneme, diphone, triphone or any other basic speech unit employed by means of a statistical function, and
to select, based on the estimation of said first duration information, a stored acoustic unit of the syllable, phoneme, half-phoneme, diphone, triphone or any other basic speech unit employed from an acoustic data database to be concatenated to form synthetic speech.

17. A device according to claim 16, wherein said statistical function includes one of: a probability model; uniform probability model; Gaussian probability model; curve fitting to a sorted duration curve; polynomial quantization; spline quantization; and vector quantization.

18. A device according to claim 16, wherein said statistical data describe behavior of duration value entries of all instances within each given syllable, phoneme, half-phoneme, diphone, triphone or any other basic speech unit employed.

19. A device according to claim 16, wherein said statistical data include at least one of: statistical parameters of durations for each given syllable, phoneme, half-phoneme, diphone, triphone or any other basic speech unit employed among the acoustic units; a mean value of durations for each given syllable, phoneme, half-phoneme, diphone, triphone or any other basic speech unit employed; and a deviation of durations for each given syllable, phoneme, half-phoneme, diphone, triphone or any other basic speech unit employed.

20. A data storage encoded with an executable program that, when run on a computing device, cause the device
to analyze the text and producing phonetic presentation of a text input,
to select from said memory, based on said phonetic presentation, compressed duration information of a given syllable, phoneme, half-phoneme, diphone, triphone or any other basic speech unit employed,
to decompress said compressed duration information by producing from said statistical data an estimation of said first duration information of the syllable, phoneme, half-phoneme, diphone, triphone or any other basic speech unit employed by means of a statistical function, and
to select, based on the estimation of said first duration information, a stored acoustic unit of the syllable, phoneme, half-phoneme, diphone, triphone or any other basic speech unit employed from an acoustic data database to be concatenated to form synthetic speech.

21. An executable program code that, when run on a computing device, cause the device to perform the method steps of claim 1.

22. A device for creating prosodic information for a concatenative text-to-speech synthesis system, comprising
analyzer analysing training speech samples and generating acoustic units and associated prosodic information for selection of said acoustic units, said prosodic information including first duration information,
compressor compressing the first duration information by producing statistical data describing the behavior of the first duration information,
memory storing said prosodic information wherein the first duration information is replaced by said statistical data, thereby reducing a memory capacity required for storing said prosodic information.

23. A device according to claim 22, wherein said statistical data include statistical parameters of durations for each given syllable, phoneme, half-phoneme, diphone, triphone or any other basic speech unit employed among the acoustic units.

24. A device according to claim 22, wherein said statistical data describe behavior of duration value entries of all instances within each given syllable, phoneme, half-phoneme, diphone, triphone or any other basic speech unit employed.

25. A device according to claim 22, wherein said statistical data include at least one of a mean value and a deviation of durations for each given syllable, phoneme, half-phoneme, diphone, triphone or any other basic speech unit employed.

26. A device according to claim 22, comprising sorting entries of each given syllable, phoneme, half-phoneme, diphone, triphone or any other basic speech unit employed in the order of increasing duration values.

27. A concatenative text-to-speech synthesis system, comprising
means analysing training speech samples and generating acoustic units and associated prosodic information for selection of said acoustic units, said prosodic information including first duration information,
means compressing the first duration information by producing statistical data describing the behavior of the first duration information of each syllable, phoneme, half-phoneme, diphone, triphone or any other basic speech unit employed,
means storing a lexicon for the text analyzer, voice data including said acoustic units, and said associated prosodic information containing said compressed duration information,
means producing phonetic presentation of a text input;
means decompressing said compressed duration information by a predetermined statistical function producing an estimation of said first duration information of the syllable, phoneme, half-phoneme, diphone, triphone or any other basic speech unit employed based on the statistical data;
means selecting, based on the estimation of said first duration information and other prosodic information, a stored acoustic unit of the syllable, phoneme, half-phoneme, diphone, triphone or any other basic speech unit employed from an acoustic data database to be concatenated to form synthetic speech.
